(19) United States
(12) Patent Application Publication
(10) Pub. No.: US 2023/0256276 A1
(43) Pub. Date: Aug. 17, 2023

(54) Fire Extinguisher Mounting Bracket

(71) Applicant: Veronica Salas, Thermal, CA (US)

(72) Inventor: Veronica Salas, Thermal, CA (US)

(21) Appl. No.: 18/164,766

(22) Filed: Feb. 6, 2023

Related U.S. Application Data
(60) Provisional application No. 63/307,155, filed on Feb. 6, 2022.

(51) Int. Cl. A62C 13/78; F16B 1/00; F16M 13/02

(52) U.S. Cl. CPC A62C 13/78; F16B 1/00; F16M 13/022; F16B 2001/0028

(57) ABSTRACT

A mounting bracket that is configured to hold a fire extinguisher and designed to be easily and releasably secured to a tubular mounting structure without the need to damage the tubular mounting structures with holes for fasteners. The bracket has more than one means of easily and releasably securing the fire extinguisher to itself. A foam pad is attached to the bracket and acts as an interface between the bracket and the tubular mounting structure to dampen the amount of vibration passing from the tubular mounting structure to the bracket. Finally, the bracket has a platform to support the fire extinguisher.

### CROSS-REFERENCE TO RELATED APPLICATIONS

This application claims priority from U.S. Provisional Patent Application No. 63/307,155 filed on Feb. 6, 2022. The entire disclosure of the prior application is considered to be part of the disclosure of the accompanying application and is hereby incorporated by reference.

### BACKGROUND OF THE INVENTION

### 1. Field of the Invention

The present disclosure relates generally to an apparatus for securing various articles to a structure, and more particularly, to a bracket for releasably securing a fire extinguisher to a tubular mounting structure.

### 2. Description of the Related Art

It is desirable in many settings to have a fire extinguisher nearby for use in case of an emergency. A bracket is used to mount the fire extinguisher to a structure and mounting the bracket to the structure requires fasteners such as screws to be used. Moreover, the mounting structure may be of a variety of materials and the proper fastener may not be located at the time of installation. Once the bracket has been installed, the fire extinguisher may be releasably secured to the bracket. If the location of where the bracket has been mounted must be changed, then consideration must be given to plugging the holes where the bracket was previously installed and finishing the holes so that the holes do not appear unsightly.

Examples of disclosures where the bracket is mounted to a support structure by fasteners include U.S. Pat. No. 10,415,745 to Roskamp et al., U.S. Pat. No. 7,650,948 to Rousseau et al., and U.S. Pat. No. 7,287,735 to Heerdt et al. In each of the patents identified, the bracket is mounted to a structure in a manner that requires holes to be made in the structure to receive the bracket. Time must be taken to install the brackets disclosed in these patents and then even more time is required to repair the holes created during installation when moving the brackets.

An example of a disclosure where the bracket is mounted to a tubular mounting structure is U.S. Pat. No. 10,576,316 to Kulick. In the Kulick disclosure, a second bracket assembly 18 is clamped to a tubular mounting structure so as not to damage the tubular mounting structure while first bracket assembly 16 is attached to a fire extinguisher. Then first bracket assembly 16 is releasably attached to second bracket assembly 18. However, with the Kulick disclosure, it is difficult to move to second bracket assembly 18 to another location as it is semi-permanently attached to the tubular mounting structure.

What is needed is a fire extinguisher bracket that may be securely mounted to a structure without damaging the structure and may be easily relocated to another location without the use of tools.

### BRIEF SUMMARY OF THE INVENTION

The present invention relates to a mounting bracket for fire extinguishers. One aspect of the invention relates to a bracket that does not damage the structure it is being mounted upon. Preferably the structure is roughly tubular so that mounting straps attached to the bracket may encircle the tubing. The tubular structures may be rails, posts, or a frame such as a frame that surrounds an off-road vehicle. The mounting straps may use a reusable means of connecting to one another such as hook and loop fasteners otherwise known as Velcro®, hereinafter to be referred to as fasteners.

Another aspect of the invention relates to a fire extinguisher mounting bracket having a shock-absorbing pad that acts as an interface between the bracket and the tubular mounting structure. When the bracket is mounted to a moving structure such as a boat or off-road vehicle, accelerative forces created by the moving structure need to be dampened so that the amount of fatigue experienced by the releasable mounting straps is minimized.

Another aspect of the invention relates to a fire extinguisher mounting bracket that includes a platform whereon the fire extinguisher may rest upon. Such a platform provides a degree of support for the fire extinguisher so that the amount of fatigue experienced by the releasable mounting straps is minimized.

A further aspect of the invention relates to a fire extinguisher mounting bracket that includes a platform whereon the fire extinguisher may rest upon, the platform having a wall about the platform. Such a platform provides a degree of support for the fire extinguisher so that the amount of fatigue experienced by the releasable mounting straps is minimized.

Yet another aspect of the invention relates to the dual means of securing the fire extinguisher to the bracket. The first means comprise a set of two straps that pass over the front of the fire extinguisher; the first strap passes from the top left to the bottom right while the second strap passes from the top right to the bottom left of the fire extinguisher. The second means comprise a set of two straps that pass about the circumference of the fire extinguisher; the first strap has a buckle while the second strap is capable of receiving the buckle.

Yet another aspect of the invention relates to a method of securing the bracket to a tubular mounting structure. The method includes providing a plurality of straps that wrap around openings found in the bracket as well as the tubular mounting structure itself.

The above summary of the present invention is not intended to describe each disclosed embodiment or every implementation of the present invention. Figures in the detailed description that follow more particularly exemplify certain embodiments of the invention. While certain embodiments will be illustrated and described, the invention is not limited to use in such embodiments.

### BRIEF DESCRIPTION OF DRAWINGS

The present invention will become more fully understood from the detailed description and accompanying drawings, wherein:

FIG. 1 shows an isometric view of the new fire extinguisher bracket with a fire extinguisher installed and secured to the new fire extinguisher bracket;

FIG. 2 shows an isometric view of the new fire extinguisher bracket with the fire extinguisher and all of the straps removed;

FIG. 3 shows an isometric view of the new fire extinguisher bracket with all of the straps being presented yet the fire extinguisher being removed;

FIG. 4 shows a top plan view of the new fire extinguisher bracket with the fire extinguisher and all of the straps removed;

FIG. 5 shows a right elevation view of the new fire extinguisher bracket with all of the straps being presented yet the fire extinguisher being removed; and

FIG. 6 shows a rear elevation view of the new fire extinguisher bracket with the fire extinguisher and all of the straps removed.

Like reference symbols in the various drawings indicate like elements.

### DETAILED DESCRIPTION OF THE INVENTION

The present disclosure relates to a bracket for securing a fire extinguisher in a number of different settings and to a variety of tubular mounting structures. The following description of the preferred embodiment(s) is merely exemplary in nature and is in no way intended to limit the invention, its application, or its uses.

When using navigation terms such as left or right the reference point is from the front of the bracket, ie. where the fire extinguisher exists and is relevant to a horizontal plane.

When using navigation terms such as top or bottom it is understood that the top of the bracket is opposite platform 16 while the bottom of the bracket is where platform 16 is found and is relevant to a vertical plane.

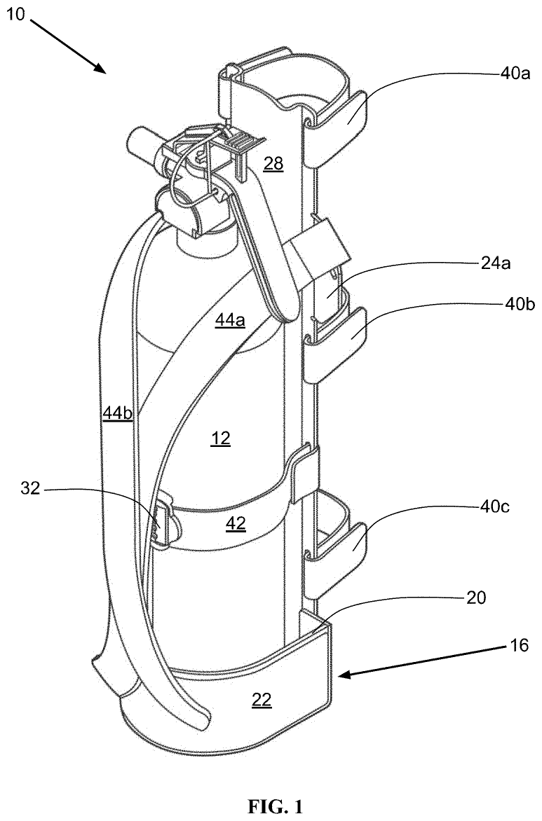

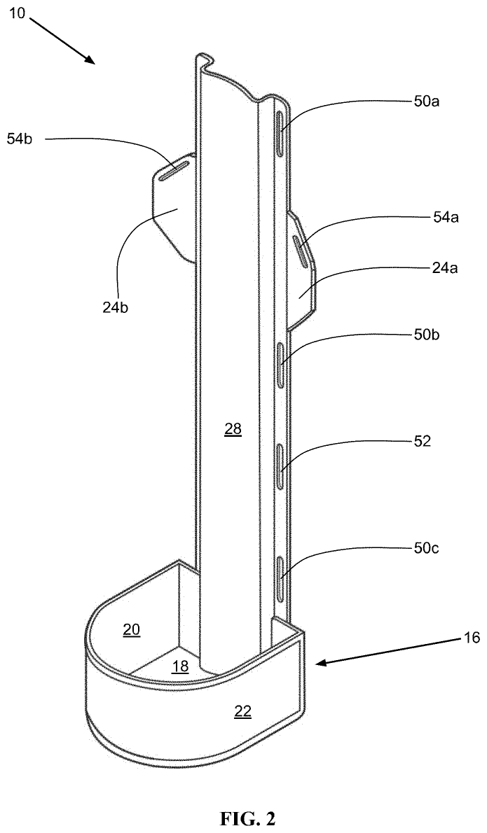

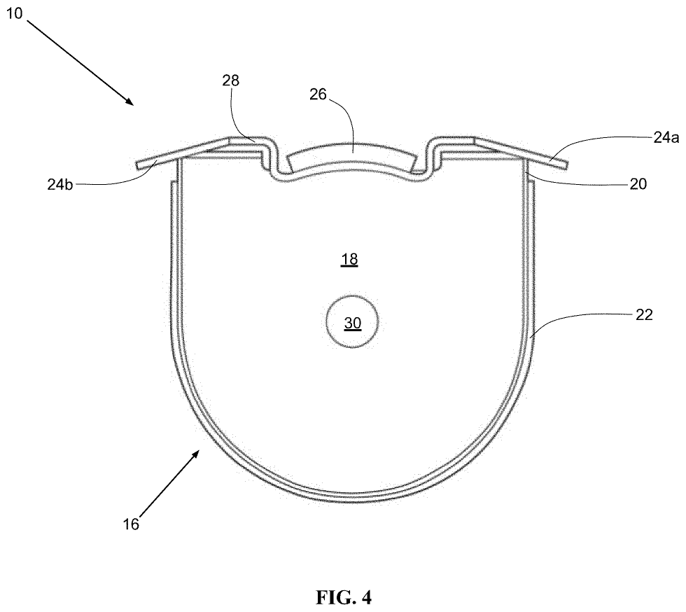

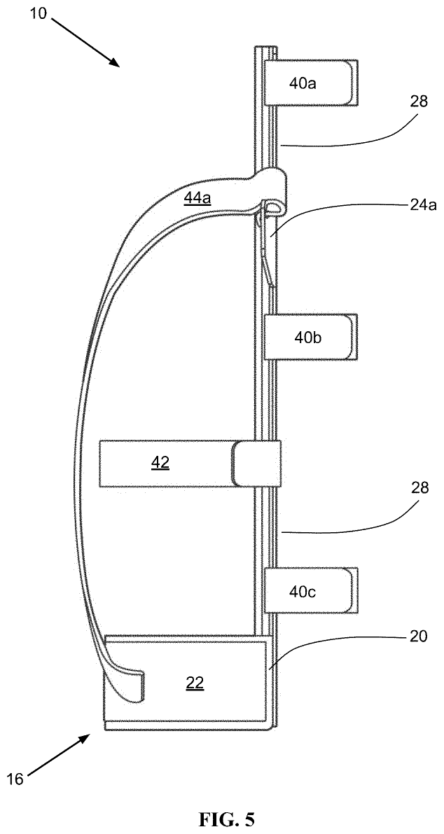

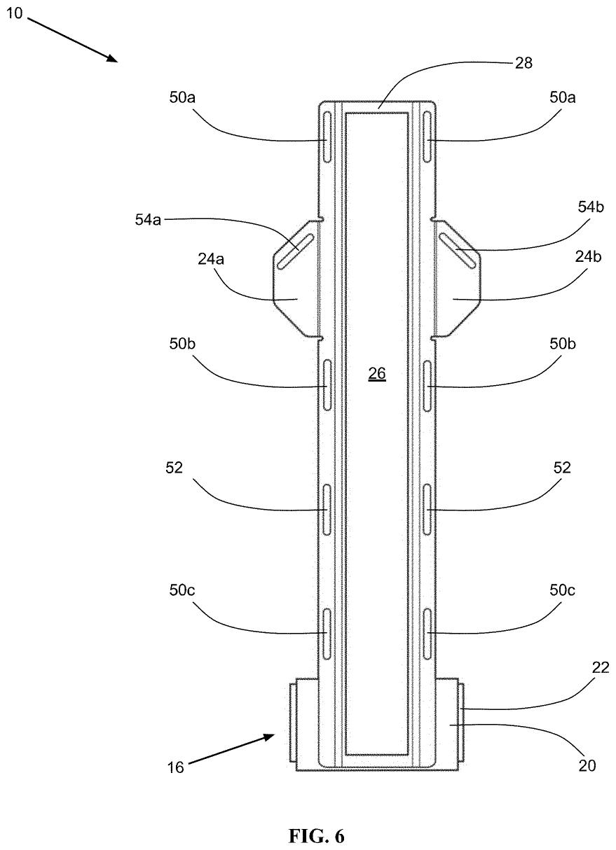

Referring now to FIG. 1 the reader is shown an isometric view of the new fire extinguisher bracket 10 with fire extinguisher 12 installed within and being secured to fire extinguisher bracket 10 by means of shoulder straps 44 and extinguisher strap 42. FIG. 1 shows that fire extinguisher bracket 10 is comprised of backplate 28, platform 16, and one or more straps. The straps are configured with hook and loop fasteners so that the straps may be releasably attached to themselves and/or other elements of fire extinguisher bracket 10. It is noticed that backplate 28 extends the entire vertical length of fire extinguisher bracket 10 and includes left projection 24b and right projection 24a, which are positioned along and on either side of backplate 28 opposite the neck of fire extinguisher 12. Such a placement will allow fire extinguisher 12 to be secured to fire extinguisher bracket 10 by means of shoulder straps 44. At the bottom of fire extinguisher bracket 10 is found platform 16 whereon fire extinguisher 12 may be supported. It is noticed that platform 16 is comprised of deck 18 and wall 20 which is formed along the edge of deck 18. While deck 18 provides support for holding fire extinguisher 12, wall 20 serves a dual purpose. First, wall 20 prevents fire extinguisher 12 from slipping off of deck 18, and second, wall 20 has on its outer surface fabric 22 that releasably engages with corresponding fasteners found on the distal ends of shoulder straps 44. As shown in FIG. 1, shoulder straps 44 are anchored to openings found in projections 24. That is right shoulder strap opening 54a is found in right projection 24a and is used to anchor right shoulder strap 44a while left shoulder strap opening 54b is found in left projection 24b and is used to anchor left shoulder strap 44b. Note that while left shoulder strap opening 54b and left projection 24b are not visible in FIG. 1, they are visible in FIGS. 2 and 6. Each shoulder straps 44 has on its distal ends fasteners to engage the fasteners found on fabric 22. In this manner, fire extinguisher 12 will be held securely to fire extinguisher bracket 10. Another means to secure fire extinguisher 12 to fire extinguisher bracket 10 is by using extinguisher strap 42. It is noticed that extinguisher strap 42 comprises two straps. A first strap, the proximal end thereof attached to extinguisher strap openings 52 on the left side of backplate 28, has buckle 32 attached to its distal end. A second strap, the proximal end thereof attached to extinguisher strap openings 52 on the right side of backplate 28, has a distal end that receives buckle 32 so as to secure fire extinguisher 12 to fire extinguisher bracket 10. To secure fire extinguisher bracket 10 to a tubular mounting structure are attachment straps 40. Attachment straps 40 are comprised of three identical sets of straps: upper attachment strap 40a, mid attachment strap 40b, and lower attachment strap 40c. The ends of upper attachment strap 40a, mid attachment strap 40b, and lower attachment strap 40c pass about the tubular mounting structure and into upper openings 50a, mid openings 50b, and lower openings 50c respectively, then reversing back onto itself as shown in FIGS. 1, 3, and 5. In yet another embodiment, the proximal end of attachment straps 40 may be permanently attached to one of upper openings 50a, mid openings 50b, or lower openings 50c while the distal end passes about the tubular mounting structure and then into the opposing opening and finally reversing back onto itself. Finally, not visible in FIG. 1 but shown in FIGS. 4 and 5, is foam pad 26. It is noticed that foam pad 26 is attached to the back of backplate 28 by means of an adhesive and operates as an interface between backplate 28 and whatever tubular mounting structure fire extinguisher bracket 10 is to be attached to. This will allow foam pad 26 to absorb vibrations being transmitted from the tubular mounting structure for the purposes of preventing fire extinguisher bracket 10 from being detached from the tubular mounting structure. Foam pad 26 may also be attached to the front of backplate 28 so as to absorb vibrations caused by fire extinguisher 12.

In FIG. 2, the reader is shown an isometric view of fire extinguisher bracket 10 without fire extinguisher 12 or any of the straps. This view allows the reader to gain a better understanding of fire extinguisher bracket 10 as its individual elements are more clearly shown. Here backplate 28 and platform 16 are clearly visible. Present along and on either side of backplate 28 are shown projections 24 comprised of left projection 24b containing left shoulder strap opening 54b and right projection 24a containing right shoulder strap opening 54a. Left shoulder strap opening 54b and right shoulder strap opening 54a are used to retain left shoulder strap 44b and right shoulder strap 44a respectively. The remaining sets of openings along and on either side of backplate 28: upper openings 50a, mid openings 50b, lower openings 50c, and extinguisher strap openings 52, are used in the operation of upper attachment strap 40a, mid attachment strap 40b, lower attachment strap 40c, and extinguisher strap 42 respectively. Additionally, the reader may notice that platform 16 is comprised of deck 18 and wall 20. The purpose of deck 18 is to provide a support stand for fire extinguisher 12 to rest upon while the purpose of wall 20 is twofold, first to prevent fire extinguisher 12 from slipping away from deck 18 and second to provide a surface for which to attach fabric 22. Fabric 22 is composed of fasteners that may be releasably attached to corresponding fasteners found on the distal ends of shoulder straps 44 when securing fire extinguisher 12 to fire extinguisher bracket 10.

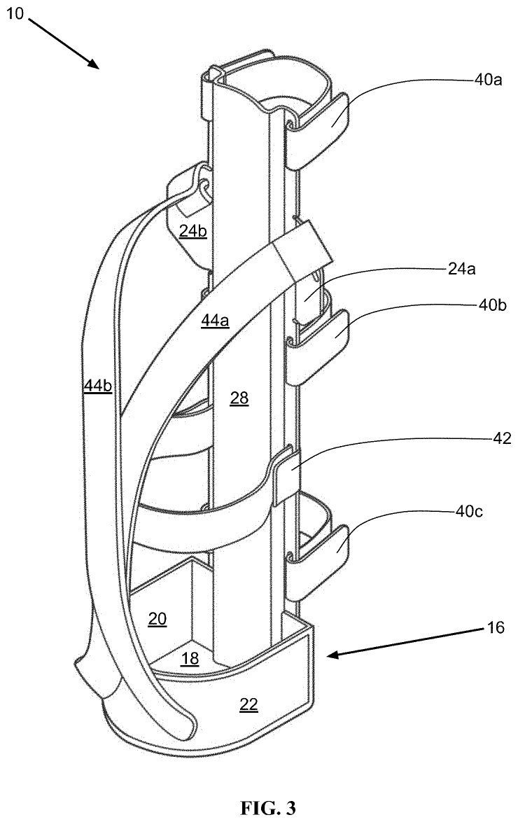

Turning now to FIG. 3, the reader is shown the same isometric view as shown in FIG. 2 but with shoulder straps 44, attachment straps 40, and extinguisher strap 42 being shown.

In FIG. 4 the reader is presented with a top plan view of fire extinguisher bracket 10 without shoulder straps 44, attachment straps 40, and extinguisher strap 42 being shown. In FIG. 4 the reader is shown foam pad 26 which is used to absorb vibrations that are being transmitted from the tubular mounting structure that fire extinguisher bracket 10 is attached to. Absorption of the vibrations will assist fasteners found in upper attachment strap 40a, mid attachment strap 40b, and lower attachment strap 40c in securing fire extinguisher bracket 10 to whatever tubular mounting structure it is attached to. In FIG. 4, deck 18 is shown with drain 30. Drain 30 is one or more openings generally located about the center of deck 18 to allow liquid collected on platform 16 to drain. Also shown in FIG. 4 is fabric 22 which is attached to the outer surface of wall 20. Fabric 22 is comprised of fasteners that correspond to fasteners found on the distal ends of left shoulder strap 44b and right shoulder strap 44a to secure fire extinguisher 12 to fire extinguisher bracket 10.

In FIG. 5 the reader is presented with a right elevation view of fire extinguisher bracket 10 with all of the straps showing and without fire extinguisher 12 being installed. The left elevation view of fire extinguisher bracket 10 is the same. That is the left and right sides of fire extinguisher bracket 10 are mirror images of each other. Here the reader will notice the two elements of fire extinguisher bracket 10: (i) backplate 28 and (ii) platform 16. It is noticed that backplate 28 extends the entire vertical length of fire extinguisher bracket 10 and includes projections 24 of which only right projection 24a is visible. Projections 24 are positioned along and on either side of backplate 28 opposite the neck of fire extinguisher 12. Such a placement will allow fire extinguisher 12 to be secured to fire extinguisher bracket 10 by means of shoulder straps 44 of which only right shoulder strap 44a is visible in FIG. 5. At the bottom of fire extinguisher bracket 10 is found platform 16 whereon fire extinguisher 12 may be supported. It is noticed that platform 16 is comprised of deck 18, which is not visible in this figure but visible in FIGS. 2, 3, and 4, and wall 20 formed along the edge of deck 18. Wall 20 has on its outside surface fabric 22. Fabric 22 is comprised of fasteners that correspond to fasteners found on the distal ends of left shoulder strap 44b and right shoulder strap 44a to secure fire extinguisher 12 to fire extinguisher bracket 10. Attachment straps 40, comprising upper attachment strap 40a, mid attachment strap 40b, and lower attachment strap 40c, are used to secure fire extinguisher bracket 10 to a tubular mounting structure. The ends of upper attachment strap 40a, mid attachment strap 40b, and lower attachment strap 40c pass about the tubular mounting structure and into upper openings 50a, mid openings 50b, and lower openings 50c respectively, then reversing back onto itself as shown in FIGS. 1, 3, and 5. In yet another embodiment, the proximal end of attachment straps 40 may be permanently attached to one of upper openings 50a, mid openings 50b, or lower openings 50c while the distal end passes about the tubular mounting structure and then into the opposing opening and finally reversing back onto itself. Similar to attachment straps 40 but oriented in an opposite direction, is extinguisher strap 42. Extinguisher strap 42 is used to secure fire extinguisher 12 to fire extinguisher bracket 10 and is comprised of two straps, one on either side of backplate 28. The proximal ends of these straps may be permanently fastened to fire extinguisher bracket 10 through extinguisher strap openings 52 and the distal end of one strap contains buckle 32 while the distal end of the opposing strap is configured to receive buckle 32 so as to secure fire extinguisher 12 to fire extinguisher bracket 10. Another means to secure fire extinguisher 12 to fire extinguisher bracket 10 is to use shoulder straps 44. Shoulder straps 44 is comprised of two straps, one on either side of backplate 28 and referenced as left shoulder strap 44b and right shoulder strap 44a. In this figure only right shoulder strap 44a is visible but in FIGS. 1 and 3 both are visible. The proximal end of left shoulder strap 44b may be permanently attached to left shoulder strap opening 54b in left projection 24b while the proximal end of right shoulder strap 44a may be permanently attached to right shoulder strap opening 54a in right projection 24a. The distal ends of left shoulder strap 44b and right shoulder strap 44a contain fasteners that mate to fasteners found on fabric 22. By crossing shoulder straps 44 in front of fire extinguisher 12, fire extinguisher 12 may be securely attached to fire extinguisher bracket 10.

In FIG. 6 the reader is presented with a rear elevation view of fire extinguisher bracket 10 with all of the straps removed and without fire extinguisher 12 being installed. Again, the reader will notice the two elements of fire extinguisher bracket 10: (i) backplate 28 and (ii) platform 16. It is noticed that backplate 28 extends the entire vertical length of fire extinguisher bracket 10 and includes projections 24, consisting of left projection 24b and right projection 24a, as well as platform 16. Projections 24 are positioned along and on either side of backplate 28 opposite the neck of fire extinguisher 12. Such a placement will allow fire extinguisher 12 to be secured to fire extinguisher bracket 10 by means of shoulder straps 44 which are shown in FIGS. 1, 3, and 5. Also visible are openings along the edge of backplate 28 arranged in pairs from top to bottom for use by upper attachment strap 40a, mid attachment strap 40b, extinguisher strap 42, and lower attachment strap 40c. The openings consist of upper openings 50a, mid openings 50b, extinguisher strap openings 52, and lower openings 50c. At the bottom of fire extinguisher bracket 10 is found platform 16 whereon fire extinguisher 12, not visible, may be supported. It is noticed that platform 16 is comprised of deck 18, which is not visible in this figure but visible in FIGS. 2, 3, and 4, and wall 20 formed along the edge of deck 18. Wall 20 has on its outer surface fabric 22. Fabric 22 is comprised of fasteners that correspond to fasteners found on the distal ends of left shoulder strap 44b and right shoulder strap 44a to secure fire extinguisher 12 to fire extinguisher bracket 10.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims.

What is claimed is:

1. A mounting bracket that is configured to hold a fire extinguisher the mounting bracket further comprising:
a vertical and rectangular backplate portion having a top, bottom, right side, and left side the backplate further comprising:
a right upper opening proximate to said backplate's top and right side;
a left upper opening proximate to said backplate's top and left side;
a right projection below said right upper opening said right projection having an opening;
a left projection below said left upper opening said left projection having an opening;
a right mid opening below said right projection;
a left mid opening below said left projection;
a right extinguisher opening below said right mid opening;
a left extinguisher opening below said left mid opening;
a right lower opening below said right extinguisher opening;
a left lower opening below said left extinguisher opening; and
a roughly semi-elliptical platform attached to the front bottom of said backplate.

2. The mounting bracket of claim 1 wherein said platform further comprises a wall about the edge of said platform.

3. The mounting bracket of claim 2 wherein the outside surface of said wall further comprises a fabric consisting of hook or loop fasteners.

4. The mounting bracket of claim 1 wherein said platform further comprises one or more holes for drainage.
